(19) United States
(12) Patent Application Publication
(10) Pub. No.: US 2025/0219562 A1
(43) Pub. Date: Jul. 3, 2025

(54) ELECTRIC POWER CONVERSION DEVICE AND AIR CONDITIONER

(71) Applicant: Mitsubishi Electric Corporation, Tokyo (JP)

(72) Inventors: Atsushi TSUCHIYA, Tokyo (JP); Kazunori HATAKEYAMA, Tokyo (JP); Yuichi SHIMIZU, Tokyo (JP)

(21) Appl. No.: 18/709,926

(22) PCT Filed: Dec. 9, 2021
(86) PCT No.: PCT/JP2021/045325

§ 371 Date: Oct. 15, 2024

(51) Int. Cl. H02P 27/08; F24F 11/86; F24F 11/88

(52) U.S. Cl. CPC H02P 27/08; F24F 11/86; F24F 11/88; H02P 2201/15

(57) ABSTRACT

A motor driving device includes a converter, a capacitor, a voltage detector, an inverter, a current detector and a control unit. The control unit calculates a voltage command value using a voltage value detected by the voltage detector and a current value detected by the current detector, calculates a voltage phase corresponding to the voltage command value, calculates a pulsation compensation phase of a pulsating component in DC voltage inputted to the inverter from the voltage value, calculates a modulation factor from the voltage value and the voltage command value, calculates a corrected modulation factor, as a factor obtained by correcting the modulation factor so that the modulation factor increases with the increase in the voltage value, when the modulation factor is greater than 1.0, and generates a PWM signal from the corrected modulation factor and a value obtained by adding the pulsation compensation phase to the voltage phase.

### TECHNICAL FIELD

The present disclosure relates to an electric power conversion device and an air conditioner.

### BACKGROUND ART

In general, in a system that converts alternating current from a single-phase AC power supply to direct current with a converter, smoothes the direct current with a DC capacitor, and further converts the smoothed direct current to alternating current at an arbitrary frequency with an inverter, harmonics are superimposed on the current flowing from the converter to the capacitor and thus DC link voltage pulsates.

Further, when three-phase AC voltage is generated from DC voltage by an inverter, a beat phenomenon of phase currents and ripples in torque occur due to the pulsation of the DC link voltage and become problems.

In order to restrain such pulsation, Patent Reference 1 discloses an electric power conversion device in which a phase regulator calculates a phase adjustment amount ΔP from the d-axis regarding an output voltage vector command based on the pulsation of the DC link voltage and adds a phase reference P* from the d-axis thereto.

### PRIOR ART REFERENCE

### Patent Reference

Patent Reference 1: Japanese Patent Application Publication No. H11-89297

### SUMMARY OF THE INVENTION

### Problem to be Solved by the Invention

The conventional technology restrains a rapid change or a jump in the motor current by compensating the DC voltage for a phase of output voltage in an overmodulation region.

Further, the conventional technology sets a voltage limit value in regard to the amplitude of the voltage, and in this case, when pulsation of bus voltage inputted to the inverter changes rapidly, output voltage of the inverter has to be increased in order to output necessary torque current; however, a necessary voltage value cannot be outputted due to the voltage limit value and accordingly a peak value of the motor current is necessitated to fluctuate.

It is therefore an object of one or more aspects of the present disclosure to make it possible to reduce the capacitance of the smoothing capacitor placed in the input stage of the inverter without the need of narrowing the operating range of the motor.

### Means for Solving the Problem

An electric power conversion device according to an aspect of the present disclosure includes a converter that rectifies inputted AC voltage, a capacitor that turns an output of the converter into DC voltage by smoothing the output, a voltage detector that detects a voltage value of the DC voltage, an inverter that converts the DC voltage to three-phase AC voltage, a current detector that detects a current value of current outputted from the inverter, and a control unit that controls the inverter. The control unit includes a voltage command value calculation unit that calculates a voltage command value as a command value regarding voltage applied to the inverter by using the voltage value and the current value, a phase calculation unit that calculates a voltage phase corresponding to the voltage command value, a pulsation phase compensation unit that extracts a pulsation component due to the DC voltage that is superimposed on the voltage command value generated from the voltage value and calculates a pulsation compensation phase as a phase of the pulsation component, a modulation factor compensation unit that calculates a modulation factor from the voltage value and the voltage command value and calculates a corrected modulation factor, as a factor obtained by correcting the modulation factor, when the modulation factor is greater than 1.0 so that the voltage value can be outputted linearly with respect to the voltage command value, and a PWM generation unit that generates a PWM (Pulse Width Modulation) signal for controlling the inverter from the corrected modulation factor and a value obtained by adding the pulsation compensation phase to the voltage phase.

An air conditioner according to an aspect of the present disclosure includes the above-described electric power conversion device, a motor that is driven by the three-phase AC voltage outputted from the electric power conversion device and generates motive power, and a compressor that compresses a refrigerant by using the motive power.

### Effect of the Invention

According to one or more aspects of the present disclosure, the capacitance of the smoothing capacitor placed in the input stage of the inverter can be reduced without the need of narrowing the operating range of the motor.

### BRIEF DESCRIPTION OF THE DRAWINGS

FIG. 1 is a block diagram schematically showing the configuration of an air conditioner according to an embodiment.

FIG. 2 is a circuit diagram schematically showing the configuration of a motor driving device and a motor.

FIG. 3 is a graph showing a U-phase voltage command value when voltage is applied to the U-phase in a sinusoidal wave mode.

FIG. 4 is a graph showing the U-phase voltage command value when voltage is applied to the U-phase in a trapezoidal wave mode.

FIGS. 5A and 5B are graphs showing phase currents varying corresponding to capacitance of a capacitor.

FIG. 6 is a block diagram schematically showing the configuration of a control unit.

FIG. 7 is a block diagram schematically showing the configuration of a pulsation phase compensation unit and a modulation factor compensation unit.

FIG. 8 is a graph showing an operation frequency of the motor and an inductive voltage characteristic of the motor at an output voltage of an inverter.

FIG. 9 is a graph showing an example of a modulation factor correction table.

FIGS. 10A and 10B are graphs for comparing a motor phase current waveform when both of amplitude and a phase of the output voltage of the inverter are controlled.

FIGS. 11A and 11B are block diagrams showing hardware configuration examples.

FIG. 12 is a block diagrams showing a first modification of the modulation factor compensation unit.

FIG. 13 is a block diagrams showing a second modification of the modulation factor compensation unit.

### MODE FOR CARRYING OUT THE INVENTION

### Embodiment

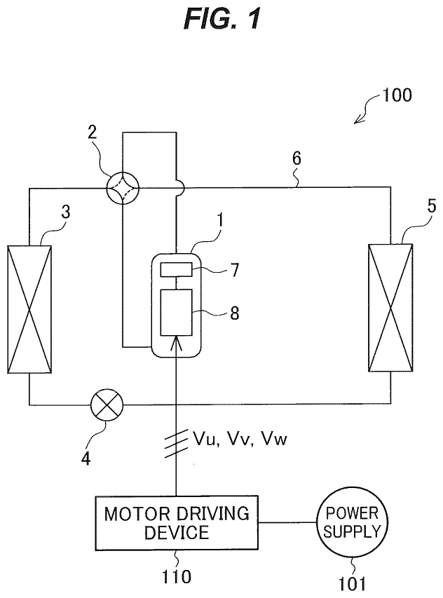

FIG. 1 is a block diagram schematically showing the configuration of an air conditioner 100 according to an embodiment.

The air conditioner 100 includes a compressor 1, a four-way valve 2, a heat exchanger 3, an expansion mechanism 4, a heat exchanger 5 and refrigerant piping 6. The compressor 1, the four-way valve 2, the heat exchanger 3, the expansion mechanism 4 and the heat exchanger 5 are connected successively via the refrigerant piping 6 and form a refrigeration cycle. The heat exchanger 3 is referred to also as a first heat exchanger and the heat exchanger 5 is referred to also as a second heat exchanger.

A compression mechanism 7 for compressing a refrigerant and a motor 8 for driving the compression mechanism 7 are provided inside the compressor 1. The motor 8 is a three-phase motor including windings of three phases: a U-phase, a V-phase and a W-phase.

The motor 8 is driven by three-phase AC voltage from a motor driving device 110 and generates motive power. Then, the compression mechanism 7 as a compressor compresses the refrigerant by using the motive power.

Further, the air conditioner 100 includes the motor driving device 110 as an electric power conversion device.

The motor driving device 110 is electrically connected to the motor 8 and drives the motor 8 by providing the motor 8 with voltage. The motor driving device 110 applies voltages Vu, Vv and Vw respectively to the U-phase, V-phase and W-phase windings of the motor 8.

The motor driving device 110 receives the supply of electric power from a power supply 101.

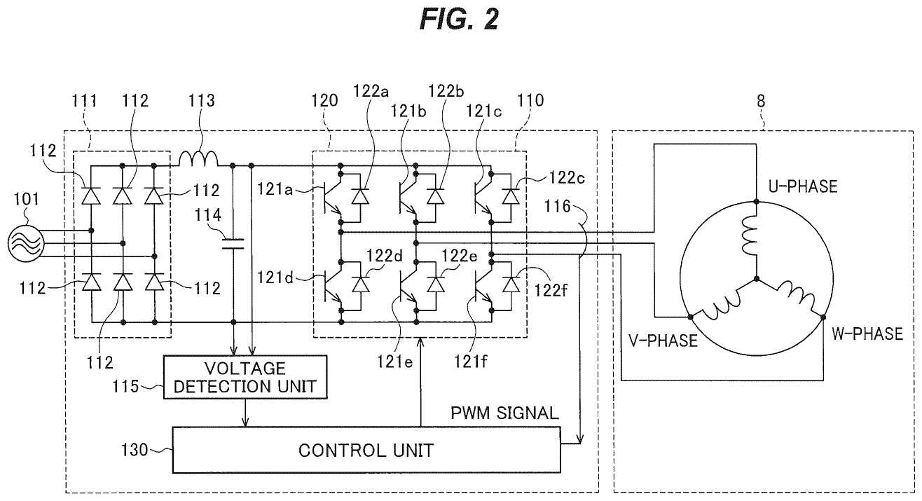

FIG. 2 is a circuit diagram schematically showing the configuration of the motor driving device 110 and the motor 8.

The motor driving device 110 includes a converter 111, a reactor 113, a capacitor 114, a voltage detector 115 as a voltage detector, a current detector 116 as a current detector, an inverter 120, and a control unit 130.

The converter 111 converts AC power from the power supply 101 to DC power. Here, the converter 111 is formed with diodes 112 for rectification. In other words, the converter 111 rectifies the inputted AC voltage. The converter 111 mentioned here is assumed to be neither a rectification circuit of the boosting type nor a power factor improvement circuit employing switching elements or the like.

The reactor 113 is connected between a positive electrode output terminal of the converter 111 and a positive electrode terminal of the inverter 120. In other words, the reactor 113 is connected in series with a positive electrode of the converter 111.

The capacitor 114 is connected between the positive electrode terminal of the inverter 120 and a negative electrode output terminal of the converter 111. The capacitor 114 turns the output of the converter 111 into DC voltage by smoothing the output.

The output from the converter 111 is smoothed by the reactor 113 and the capacitor 114.

The voltage detector 115 detects a voltage value of the DC voltage between both ends of the capacitor 114. The detected voltage value is given to the control unit 130 as a bus voltage value Vdc.

The current detector 116 detects current values Iv, Iu and Iw of the V-phase, U-phase and W-phase currents outputted from the inverter 120 and gives these current values Iv, Iu and Iw to the control unit 130.

While the current detector 116 detects all of the three-phase current values in this example, it is permissible even if current values of any two phases are detected by the current detector 116 and the current value of the remaining one phase is calculated by the control unit 130 from the detected current values of the two phases.

Further, a current detector that detects a current value of bus current may be provided instead of the current detector 116. In such a case, the control unit 130 estimates the current values of the three phases from the detected current value.

The inverter 120 converts the DC voltage to three-phase AC voltage.

For example, two switching elements 121a and 121d connected in series, two switching elements 121b and 121e connected in series, and two switching elements 121c and 121f connected in series are connected in parallel with each other in the inverter 120. The switching elements 121a to 121f are respectively provided with freewheeling diodes 122a to 122f connected in parallel therewith.

In the following description, each of the switching elements 121a to 121f will be referred to as a switching element 121 when it is not particularly necessary to discriminate among the switching elements 121a to 121f.

Further, each of the freewheeling diodes 122a to 122f will be referred to as a freewheeling diode 122 when it is not particularly necessary to discriminate among the freewheeling diodes 122a to 122f.

In the inverter 120, according to PWM (Pulse Width Modulation) signals UP, VP, WP, UN, VN, WN sent from the control unit 130, the switching elements 121 corresponding to respective PWM signals are driven. Then, the inverter 120 applies the voltages Vu, Vv and Vw corresponding to the driven switching elements 121 to the U-phase, V-phase and W-phase windings of the motor 8 respectively. By this operation, the three-phase AC voltage is applied to the motor 8.

Here, when converting the DC voltage to arbitrary voltage at an arbitrary frequency, there are cases where the inverter 120 controls the motor 8 of the compressor 1 while switching between a sinusoidal wave mode and a trapezoidal wave mode.

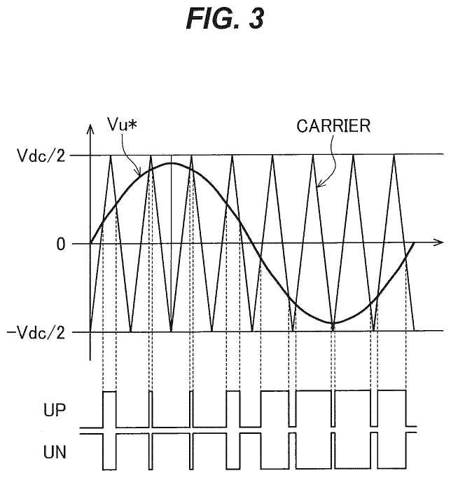

FIG. 3 is a graph showing a U-phase voltage command value Vu* as a voltage command value when voltage is applied to the U-phase in the sinusoidal wave mode.

As shown in FIG. 3, the U-phase voltage command value Vu* is compared with a carrier at a frequency fc, and a PWM signal UP for switching the switching element 121a as the U-phase upper arm is set at HIGH and outputted when the U-phase voltage command value Vu* is higher than the carrier or is set at LOW and outputted when the U-phase voltage command value Vu* is lower than the carrier. As a PWM signal UN for switching the switching element 121d as the U-phase lower arm, a signal of logic inverse to the PWM signal UP is outputted.

As shown in FIG. 3, in the sinusoidal wave mode, the amplitude of the voltage command value Vu* is smaller than ½ of the DC bus voltage value Vdc, and thus the amplitude of the voltage command value Vu* has an enough margin with respect to the bus voltage value Vdc.

FIG. 4 is a graph showing the U-phase voltage command value Vu* when voltage is applied to the U-phase in the trapezoidal wave mode.

In the trapezoidal wave mode, part of the bus voltage value Vdc equals with the voltage command value Vu* as shown in FIG. 4.

Further, in a configuration like that shown in FIG. 2, the reactor 113 and the capacitor 114 of large sizes compared to other electric components are used in many cases, and a power supply power factor tends to be low in such cases. Therefore, by reducing the capacitance of the reactor 113 and the capacitor 114, power supply harmonics can be improved and downsizing of the circuit and cost reduction become possible.

As above, due to the conversion of the AC voltage to the DC voltage, the DC voltage as the input voltage of the inverter 120 pulsates at a frequency twice the number of phases of the power supply. Further, if the capacitance of the reactor 113 and the capacitor 114 is reduced for the purposes of the downsizing of the device and the cost reduction, the pulsation of the DC voltage increases. Therefore, the inverter 120 needs to control the AC voltage of arbitrary frequency and amplitude based on the DC voltage having great pulsation.

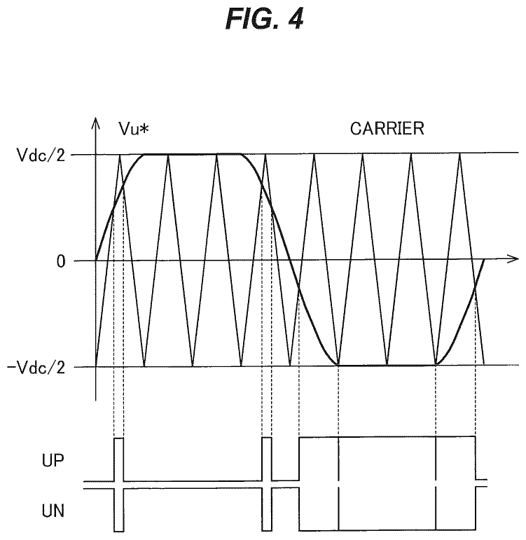

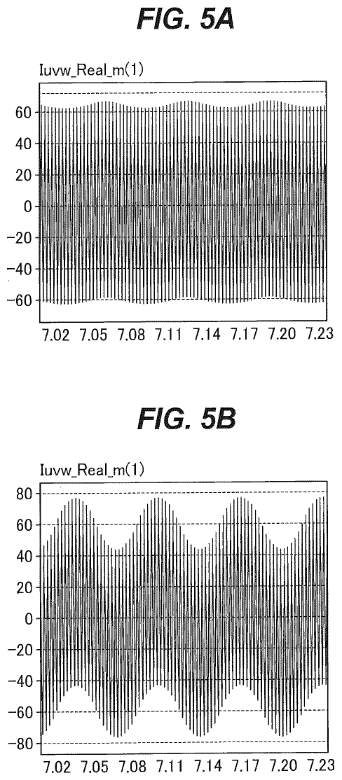

For example, in an operation in the trapezoidal wave mode in which the output voltage of the inverter 120 is nonlinear with respect to the voltage command value V*, there occurs a situation in which the voltage command value V* outputted by the inverter 120 cannot be outputted exactly like a voltage vector necessary for the rotation of the motor 8 due to influence of the pulsation of the bus voltage. For example, FIG. 5A shows the phase currents of the motor 8 when the capacitance of the capacitor 114 is high, and FIG. 5B shows the phase currents of the motor 8 when the capacitance of the capacitor 114 is low. As shown in FIG. 5B, when the capacitance of the capacitor 114 is low, the phase currents of the motor 8 pulsate due to the influence of the pulsation of the bus voltage value Vdc. In this casa, the current peak value is necessitated to fluctuate.

When the peak value of the phase currents of the motor 8, which is, for example, a synchronous motor of the permanent magnet type, fluctuates, current higher than or equal to a demagnetization current flows in the vicinity of an operation limit and that causes irreversible demagnetization to the property of the permanent magnets. Further, even when the control is executed so as not to exceed a set current, there is a possibility that the operating range of the motor 8 narrows. Furthermore, overcurrent leads to vibration or noise of the compressor 1 including the motor 8 and that can lead to an abnormal stoppage, breakage, abnormal noise or the like.

Therefore, to deal with the above-described problems, control executed by the control unit 130 controlling the inverter 120 will be described below.

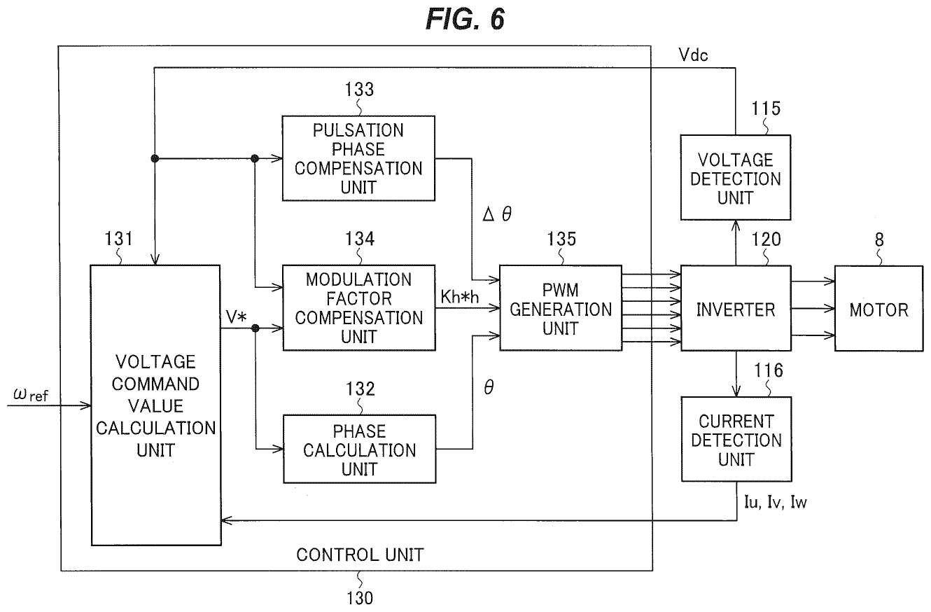

FIG. 6 is a block diagram schematically showing the configuration of the control unit 130.

The control unit 130 includes a voltage command value calculation unit 131, a phase calculation unit 132, a pulsation phase compensation unit 133, a modulation factor compensation unit 134 and a PWM generation unit 135.

The voltage command value calculation unit 131 calculates the voltage command value V* as a command value regarding the voltage applied to the inverter 120 by using the bus voltage value Vdc detected by the voltage detector 115 and the current values Iu, Iv and Iw of the respective phases detected by the current detector 116. In this example, the voltage command value calculation unit 131 calculates the voltage command value V* by using the bus voltage value Vdc and the current values Iu, Iv and Iw so that the motor 8 can rotate at a revolution speed indicated by a speed command value ω_{ref} as a command value regarding the revolution speed of the motor 8 given from the outside. The calculated voltage command value V* is given to the modulation factor compensation unit 134 and the phase calculation unit 132.

Processing by the voltage command value calculation unit 131 is known processing such as three-phase to two-phase conversion, rotational coordinate transformation, PI control and fixed coordinate transformation, and thus detailed description thereof is omitted.

The phase calculation unit 132 calculates a voltage phase corresponding to the voltage command value V*.

For example, the phase calculation unit 132 calculates the voltage phase θ from the voltage command value V*=(Vd*, Vq*) according to the following expression

$$θ = {tan}^{- 1} ( {Vq}^{*} / {Vd}^{*} ) \qquad ( 1 )$$

The pulsation phase compensation unit 133 calculates a pulsation compensation phase Δθ, as a phase of a pulsating component in the DC voltage inputted to the inverter 120, from the bus voltage value Vdc. For example, the pulsation phase compensation unit 133 extracts the pulsation component due to the DC voltage that is superimposed on the voltage command value V* generated from the bus voltage value Vdc, and calculates the pulsation compensation phase as the phase of the pulsation component.

The modulation factor compensation unit 134 calculates a modulation factor from the bus voltage value Vdc and the voltage command value V*.

Then, when the modulation factor is greater than 1.0, the modulation factor compensation unit 134 calculates a corrected modulation factor Kh*h, as a factor obtained by correcting the modulation factor, so that the bus voltage value Vdc can be outputted linearly with respect to the voltage command value V*. In this example, when the modulation factor is greater than 1.0, the modulation factor compensation unit 134 calculates the corrected modulation factor Kh*h as a factor obtained by correcting the modulation factor so that the factor takes on a greater value as the bus voltage value Vdc increases.

The PWM generation unit 135 generates the PWM signals for controlling the inverter 120 from the corrected modulation factor Kh*h and a value obtained by adding the pulsation compensation phase Δθ to the voltage phase θ. Since the effect of inhibiting the current pulsation cannot be obtained sufficiently in a region where the modulation factor is greater than or equal to 1.0 when only the pulsation compensation phase Δθ is used, the PWM generation unit 135 in this embodiment uses both of the pulsation compensation phase Δθ and the corrected modulation factor Kh*h and thereby obtains the current pulsation inhibition effect also in the region where the modulation factor is greater than or equal to 1.0. The generated PWM signals are outputted to the inverter 120.

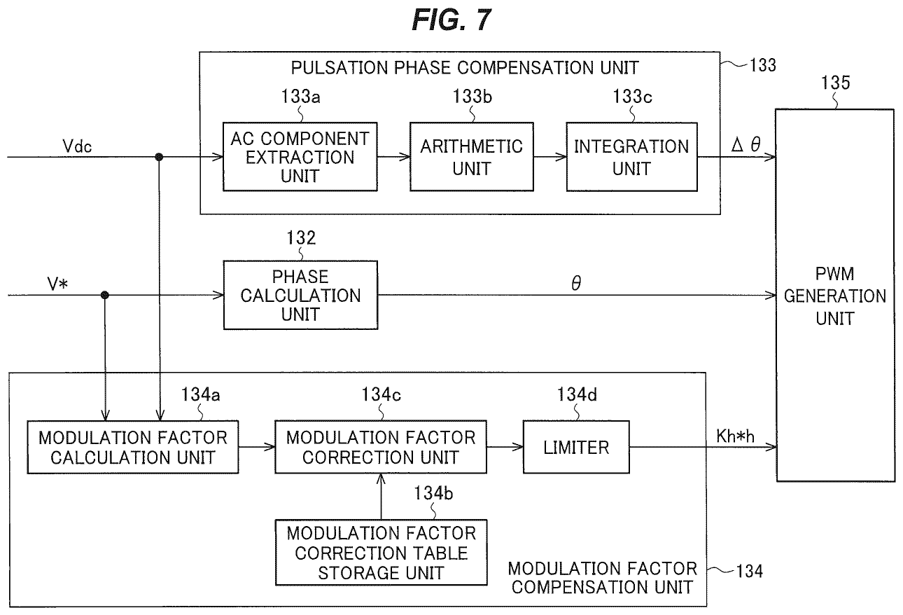

FIG. 7 is a block diagram schematically showing the configuration of the pulsation phase compensation unit 133 and the modulation factor compensation unit 134.

The pulsation phase compensation unit 133 calculates the pulsation compensation phase Δθ as the phase of the pulsating component in the bus voltage value Vdc.

The pulsation phase compensation unit 133 includes an AC component extraction unit 133a, an arithmetic unit 133b and an integration unit 133c.

The AC component extraction unit 133a extracts only the pulsation component, which is the component pulsating in the bus voltage value Vdc, by performing filter processing by use of a bandpass filter on the bus voltage value Vdc. In the bus voltage value Vdc, a frequency component at twice the product of the power supply frequency and the number of phases as shown in the following expression (2) mainly pulsates. Therefore, a frequency component at six times the power supply frequency increases in cases of a three-phase AC power supply, and a frequency component at twice the power supply frequency increases in cases of a single-phase AC power supply. Accordingly, the AC component extraction unit 133a extracts the frequency in this part.

$$power supply frequency \times the number of phase \times 2 \qquad ( 2 )$$

The arithmetic unit 133b divides the pulsation component extracted by the AC component extraction unit 133a by the bus voltage value Vdc and thereby converts the voltage value to a frequency component.

The integration unit 133c calculates the pulsation compensation phase Δθ by integrating the frequency component of the pulsation calculated by the arithmetic unit 133b. The calculated pulsation compensation phase Δθ is given to the PWM generation unit 135.

The modulation factor compensation unit 134 includes a modulation factor correction table storage unit 134b, a modulation factor correction unit 134c and a limiter 134d so that a modulation factor corresponding to the voltage command value V* can be calculated by a modulation factor calculation unit 134a and the output voltage can be outputted linearly with respect to the modulation factor.

With this configuration, the linear outputting becomes possible also for output voltage fluctuation due to the pulsation component of the bus voltage value Vdc even when the modulation factor is greater than or equal to 1.0.

The modulation factor calculation unit 134a calculates the modulation factor Kh according to the following expression (3). The calculated modulation factor Kh is given to the modulation factor correction unit 134c.

$$Kh = \frac{V *}{Vdc \sqrt{2}} \qquad ( 3 )$$

The modulation factor correction table storage unit 134b stores a modulation factor correction table indicating modulation factor correction coefficients for correcting the modulation factor.

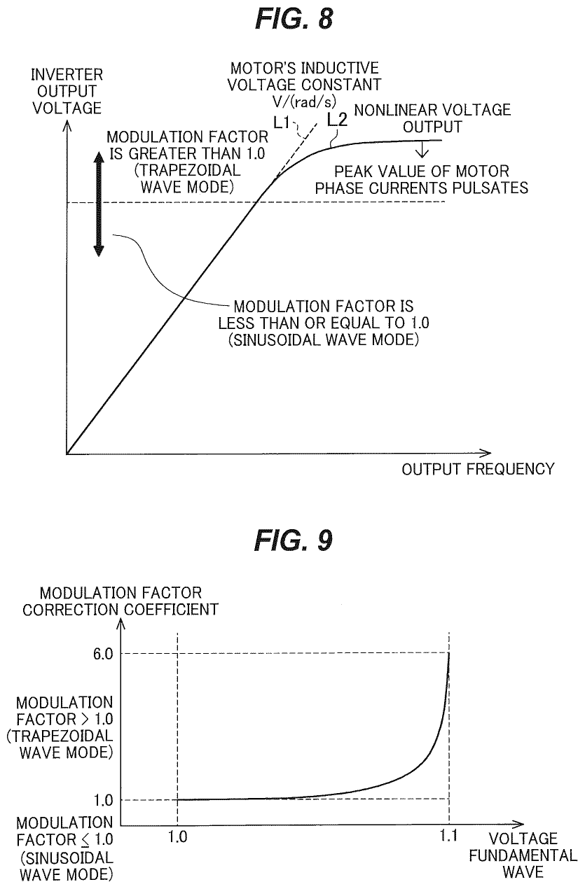

FIG. 8 is a graph showing an operation frequency of the motor 8 and an inductive voltage characteristic of the motor 8 at the output voltage of the inverter 120.

As shown in FIG. 8, in the sinusoidal wave mode in which the modulation factor Kh is less than or equal to 1.0, the operation frequency of the motor 8 and the output voltage of the inverter 120 exhibit a linear characteristic.

However, in the trapezoidal wave mode in which the modulation factor Kh is greater than 1.0, the operation frequency of the motor 8 and the output voltage of the inverter 120 exhibit a nonlinear characteristic.

In the trapezoidal wave mode, there is a part where the voltage command value V* equals the bus voltage value Vdc as explained earlier with reference to FIG. 4. Thus, if the bus voltage value Vdc is pulsating, the pulsation is outputted to the motor 8 via the inverter 120.

To avoid such a situation, in this embodiment, the modulation factor correction coefficients, with which the modulation factor turns into a modulation factor in a case where the operation frequency of the motor 8 and the output voltage of the inverter 120 are assumed to be in a linear characteristic, are indicated by the modulation factor correction table.

Specifically, a value by which the modulation factor Kh should be multiplied in order to raise the solid line L2 shown in FIG. 8 to the broken line L1 is identified as the modulation factor correction coefficient.

FIG. 9 is a graph showing an example of the modulation factor correction table.

The voltage fundamental wave shown in FIG. 9 means a fundamental wave frequency component of the voltage command value like the sin wave of Vu* shown in FIG. 3. For example, in cases of a synchronous motor, as the fundamental wave component of the voltage command value, a frequency component corresponding to an electric angle frequency component of the number of revolutions of the motor forms the voltage fundamental wave.

Although the relationship between this voltage fundamental wave component and the modulation factor is 1:1 (linear) in the range where the modulation factor does not exceed 1.0, Vu* is limited by Vdc/2 when the modulation factor exceeds 1.0 as shown in FIG. 4, for example. Since the fundamental wave component corresponding to Vu* in this case and the modulation factor become nonlinear, a relationship like that shown in FIG. 8 is caused.

Thus, a table with which the voltage fundamental wave component and the modulation factor become a linear output is the graph shown in FIG. 9. In the graph shown in FIG. 9, the horizontal axis represents the voltage fundamental wave component and the vertical axis represents a modulation factor value (=the modulation factor correction coefficient) necessary for the modulation factor and the voltage fundamental wave component to become linear.

Specifically, in a region where the modulation factor is less than or equal to 1.0, the line-to-line voltage outputted by the inverter 120 is in a shape like a sinusoidal wave and thus the fundamental wave of the output voltage corresponds to a sinusoidal wave component. However, when the modulation factor exceeds 1.0, the line-to-line voltage of the output of the inverter 120 turns into a shape like a rectangular wave, and the amplitude of the rectangular wave-like voltage does not correspond to the amplitude of the fundamental wave component.

Therefore, the extent to which the modulation factor should be outputted in regard to a voltage rectangular wave-like line-to-line voltage, which is the voltage actually applied to the motor 8, can be calculated by calculating the fundamental wave component of rectangular wave voltage with respect to the modulation factor and the rectangular wave-like line-to-line voltage.

Here, a diagram in which the modulation factor is represented by the horizontal axis and the output voltage is represented by the vertical axis is FIG. 8.

In contrast, a diagram in which the fundamental wave component of the output voltage is represented by the horizontal axis and the modulation factor at that time is represented by the vertical axis is FIG. 9. By abiding by the modulation factor correction table shown in FIG. 9, a modulation factor corresponding to a desirable voltage to be outputted can be obtained in a table-like manner. In FIG. 9, it becomes possible to output voltage up to a maximum of 1.1 times relative to the amplitude of the voltage that can be outputted as a sinusoidal wave.

The modulation factor correction unit 134c calculates a provisionally corrected modulation factor Kh* by multiplying the modulation factor Kh from the modulation factor calculation unit 134a by the modulation factor correction coefficient corresponding to the modulation factor Kh. The calculated provisionally corrected modulation factor Kh* is given to the limiter 134d.

When the provisionally corrected modulation factor Kh* is greater than or equal to a predetermined upper limit, the limiter 134d fixes the provisionally corrected modulation factor Kh* at the upper limit and thereby prevents the modulation factor for controlling the inverter 120 from becoming excessively great. Since there is a limitation on linearly outputting the voltage fundamental wave and the modulation factor as explained earlier, the limiter 134d is provided so as not to use a value greater than or equal to a value corresponding to the limitation. The limiter 134d gives the value after the processing to the PWM generation unit 135 as the corrected modulation factor Kh*h.

The PWM generation unit 135 generates the PWM signals based on the pulsation compensation phase Δθ from the pulsation phase compensation unit 133, the corrected modulation factor Kh*h from the modulation factor compensation unit 134 and the phase θ from the phase calculation unit 132, and outputs the PWM signals to the inverter 120.

For example, the PWM generation unit 135 may calculate a control phase θ# by adding the pulsation compensation phase Δθ to the phase θ and generate the PWM signals based on the control phase θ# and the corrected modulation factor Kh*h.

Incidentally, the process of generating the PWM signals from the phase and the modulation factor may be executed according to a conventional process, and thus detailed description thereof is omitted.

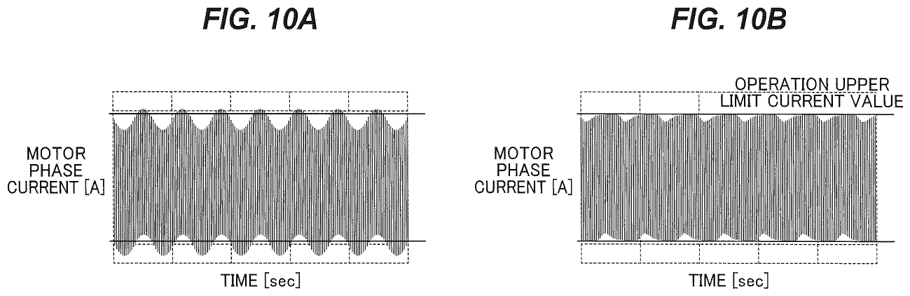

Comparison of the motor phase current waveform when both of the amplitude and the phase of the output voltage of the inverter 120 are controlled is shown in FIGS. 10A and 10B.

FIG. 10A shows the motor phase current waveform when the control of both of the amplitude and the phase of the output voltage of the inverter 120 as in this embodiment was not executed, and FIG. 10B shows the motor phase current waveform when both of the amplitude and the phase of the output voltage of the inverter 120 were controlled as in this embodiment.

As shown in FIG. 10A, when the control as in this embodiment is not executed, the peak value of the phase current waveform of the motor 8 fluctuates at a low frequency in the trapezoidal wave mode in the voltage-nonlinear region.

In contrast, in this embodiment, the pulsation of the phase current waveform of the motor 8 can be restrained as shown in FIG. 10B by changing the phase of the output voltage of the inverter 120 in adaptation to the amount of fluctuation of the DC voltage while linearly outputting the voltage even in the nonlinear region of the output voltage of the inverter 120 by compensating for the amplitude of the voltage.

While calculation on a microcomputer is possible, for example, in order to compensate for the nonlinearity of the output voltage of the inverter 120, the arithmetic processing load can be reduced by previously calculating table data like that shown in FIG. 9 and writing the table data to a storage area of the microcomputer.

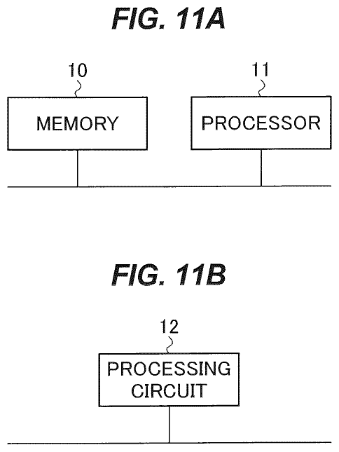

Part or the whole of the control unit 130 described above can be implemented by a memory 10 and a processor 11 such as a CPU (Central Processing Unit) that executes a program stored in the memory 10 as shown in FIG. 11A, for example. Such a program may be provided via a network, or provided in the form of being stored in a record medium. Namely, such a program may be provided as a program product, for example.

Further, part or the whole of the control unit 130 can also be implemented by a processing circuit 12 such as a single circuit, a combined circuit, a processor operating according to a program, a parallel processor operating according to a program, an ASIC (Application Specific Integrated Circuit) or an FPGA (Field Programmable Gate Array) as shown in FIG. 11B, for example.

As above, the control unit 130 can be implemented by processing circuitry.

### First Modification

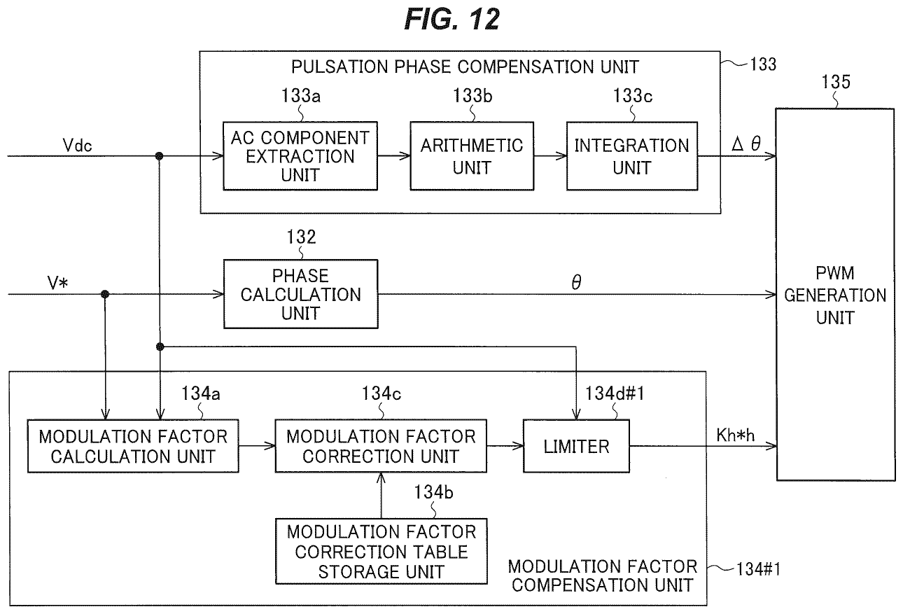

A modulation factor compensation unit 134#1 like that shown in FIG. 12 may be employed instead of the modulation factor compensation unit 134 described in the embodiment.

As shown in FIG. 12, the modulation factor compensation unit 134#1 includes the modulation factor calculation unit 134a, the modulation factor correction table storage unit 134b, the modulation factor correction unit 134c and a limiter 134d#1.

The modulation factor calculation unit 134a, the modulation factor correction table storage unit 134b and the modulation factor correction unit 134c in the modulation factor compensation unit 134#1 in the first modification are the same as the modulation factor calculation unit 134a, the modulation factor correction table storage unit 134b and the modulation factor correction unit 134c in the modulation factor compensation unit 134 in the embodiment.

The limiter 134d#1 in the first modification receives the bus voltage value Vdc from the voltage detector 115.

Then, the limiter 134d#1 further changes the voltage amplitude while securing voltage command amplitude necessary for the motor 8 by varying the upper limit in adaptation to the fluctuation of the bus voltage value Vdc. For example, the limiter 134d#1 decreases the upper limit when the fluctuation of the bus voltage value Vdc is large, and increases the upper limit when the fluctuation of the bus voltage value Vdc is small.

In this example, the limiter 134d#1 calculates the modulation factor so that the modulation factor Kh*h constantly remains within the upper limit based on instantaneous values of the bus voltage value Vdc containing the pulsation component. In a condition in which the bus voltage value Vdc is small, the modulation factor increases. Therefore, the upper limit is varied with respect to the modulation factor so that the output voltage of the inverter 120 is not limited.

This makes it possible to prevent control divergence of the output voltage of the inverter 120 while varying the amplitude and the phase of the voltage vector in addition to the control of the voltage phase in adaptation to the fluctuation of the bus voltage value Vdc by the pulsation phase compensation unit 133. Therefore, the motor phase current peak value can be stabilized while increasing responsiveness of the output voltage compensation as a whole.

### Second Modification

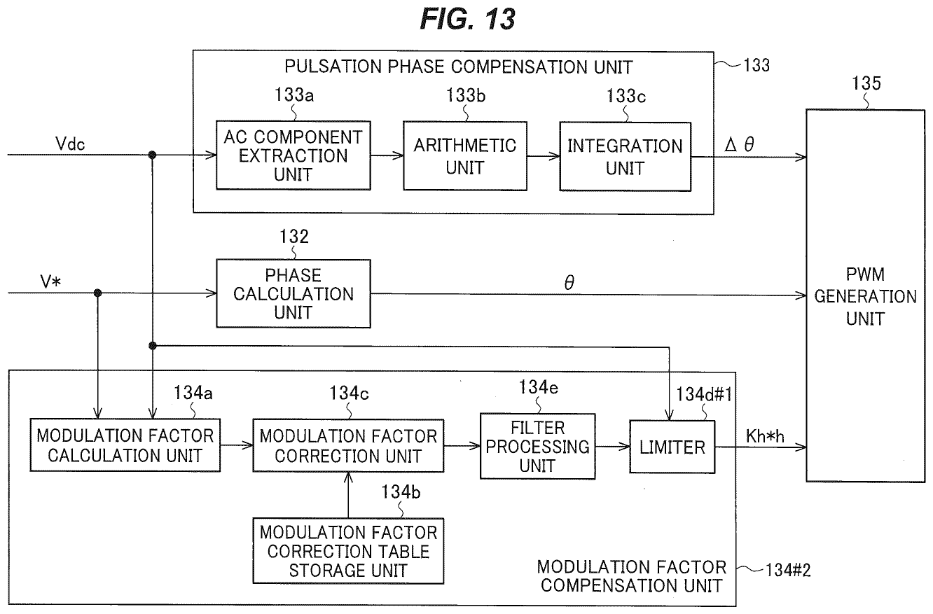

A modulation factor compensation unit 134#2 like that shown in FIG. 13 may be employed instead of the modulation factor compensation unit 134 described in the embodiment.

As shown in FIG. 13, the modulation factor compensation unit 134#2 includes the modulation factor calculation unit 134a, the modulation factor correction table storage unit 134b, the modulation factor correction unit 134c, the limiter 134d#1 and a filter processing unit 134e.

The modulation factor calculation unit 134a, the modulation factor correction table storage unit 134b and the modulation factor correction unit 134c in the modulation factor compensation unit 134#2 in the second modification are the same as the modulation factor calculation unit 134a, the modulation factor correction table storage unit 134b and the modulation factor correction unit 134c in the modulation factor compensation unit 134 in the embodiment.

Further, the limiter 134d#1 in the modulation factor compensation unit 134#2 in the second modification is the same as the limiter 134d#1 in the modulation factor compensation unit 134#1 in the first modification.

However, the limiter 134d#1 in the second modification receives a processed corrected modulation factor Kh*# after the filter processing from the filter processing unit 134e and fixes an upper limit of the processed corrected modulation factor Kh*#.

The filter processing unit 134e applies a lowpass filter to the provisionally corrected modulation factor Kh+ from the modulation factor correction unit 134c and thereby obtains the processed corrected modulation factor Kh*#.

In consideration of control stability, for example, it is appropriate to use a high cutoff frequency approximately 5 to 10 times the frequency calculated with the aforementioned expression (2) or a cutoff frequency 5 to 10 times that of the filter for the bus voltage taken into the control. When control performance is prioritized, lowering the cutoff frequencies of these filter processings is more effective.

According to the second modification, the pulsation of the motor current can be restrained while increasing the stability of the control by use of a filter by variably operating the voltage limiter while applying the filter.

While the modulation factor compensation unit 134#2 shown in FIG. 13 is provided with the limiter 134d#1 that sets the upper limit for the value after undergoing the filter processing by the filter processing unit 134e, the embodiment is not limited to such an example. For example, it is permissible even if the limiter 134d#1 is not provided. In this case, the modulation factor compensation unit 134#2 sets the corrected modulation factor Kh*h at a value obtained by performing filter processing with a lowpass filter on a value calculated by multiplying the modulation factor Kh by a modulation factor correction coefficient that becomes greater as the bus voltage value Vdc increases.

Further, while the limiter 134d#1 capable of varying the upper limit is provided in the modulation factor compensation unit 134#2 shown in FIG. 13, it is permissible even if the limiter 134d in which the upper limit is fixed is provided instead of such a limiter 134d#1.

### DESCRIPTION OF REFERENCE CHARACTERS

1: compressor, 2: four-way valve, 3: heat exchanger, 4: expansion mechanism, 5: heat exchanger, 6: refrigerant piping, 7: compression mechanism, 8: motor, 100: air conditioner, 110: motor driving device, 111: converter, 113: reactor, 114: capacitor, 115: voltage detector, 116: current detector, 120: inverter, 130: control unit, 131: voltage command value calculation unit, 132: phase calculation unit, 133: pulsation phase compensation unit, 133a: AC component extraction unit, 133b: arithmetic unit, 133c: integration unit, 134, 134#1, 134#2: modulation factor compensation unit, 134a: modulation factor calculation unit, 134b: modulation factor correction table storage unit, 134c: modulation factor correction unit, 134d, 134d#1: limiter, 134e: filter processing unit, 135: PWM generation unit

1. An electric power conversion device comprising:
a converter to rectify inputted AC voltage;
a capacitor to turn an output of the converter into DC voltage by smoothing the output;
a voltage detector to detect a voltage value of the DC voltage;
an inverter to convert the DC voltage to three-phase AC voltage;
a current detector to detect a current value of current outputted from the inverter; and
processing circuitry to control the inverter,
wherein the processing circuitry
calculates a voltage command value as a command value regarding voltage applied to the inverter by using the voltage value and the current value;
calculates a voltage phase corresponding to the voltage command value;
extracts a pulsation component due to the DC voltage and calculates a pulsation compensation phase as a phase of the pulsation component, the pulsation component being superimposed on the voltage command value generated from the voltage value;
calculates a modulation factor from the voltage value and the voltage command value and calculates a corrected modulation factor by correcting the modulation factor so that the voltage value can be outputted linearly with respect to the voltage command value when the modulation factor is greater than 1.0; and
generates a Pulse Width Modulation (PWM) signal for controlling the inverter from the corrected modulation factor and a value obtained by adding the pulsation compensation phase to the voltage phase.

2. The electric power conversion device according to claim 1, wherein the processing circuitry obtains the corrected modulation factor by multiplying the modulation factor by a modulation factor correction coefficient, the modulation factor correction coefficient becoming greater as the voltage value increases.

3. The electric power conversion device according to claim 2, wherein the processing circuitry sets an upper limit for the calculated value.

4. The electric power conversion device according to claim 1, wherein the processing circuitry sets the corrected modulation factor at a value obtained by performing filter processing with a lowpass filter on a value calculated by multiplying the modulation factor by a modulation factor correction coefficient, the modulation factor correction coefficient becoming greater as the voltage value increases.

5. The electric power conversion device according to claim 4, wherein the processing circuitry sets an upper limit for the value after undergoing the filter processing.

6. The electric power conversion device according to claim 3, wherein the processing circuitry makes the upper limit less as fluctuation of the voltage value grows larger.

7. An air conditioner comprising:
the electric power conversion device according to claim 1;
a motor to be driven by the three-phase AC voltage outputted from the electric power conversion device and to generate motive power; and
a compressor to compress a refrigerant by using the motive power.

8. The electric power conversion device according to claim 5, wherein the processing circuitry makes the upper limit less as fluctuation of the voltage value grows larger.

9. An air conditioner comprising:
the electric power conversion device according to claim 2;
a motor to be driven by the three-phase AC voltage outputted from the electric power conversion device and to generate motive power; and
a compressor to compress a refrigerant by using the motive power.

10. An air conditioner comprising:
the electric power conversion device according to claim 3;
a motor to be driven by the three-phase AC voltage outputted from the electric power conversion device and to generate motive power; and
a compressor to compress a refrigerant by using the motive power.

11. An air conditioner comprising:
the electric power conversion device according to claim 4;
a motor to be driven by the three-phase AC voltage outputted from the electric power conversion device and to generate motive power; and
a compressor to compress a refrigerant by using the motive power.

12. An air conditioner comprising:
the electric power conversion device according to claim 5;
a motor to be driven by the three-phase AC voltage outputted from the electric power conversion device and to generate motive power; and
a compressor to compress a refrigerant by using the motive power.

13. An air conditioner comprising:
the electric power conversion device according to claim 6;
a motor to be driven by the three-phase AC voltage outputted from the electric power conversion device and to generate motive power; and
a compressor to compress a refrigerant by using the motive power.

14. An air conditioner comprising:
the electric power conversion device according to claim 8;
a motor to be driven by the three-phase AC voltage outputted from the electric power conversion device and to generate motive power; and
a compressor to compress a refrigerant by using the motive power.
